(19) United States
(12) Patent Application Publication
(10) Pub. No.: US 2016/0107555 A1
(43) Pub. Date: Apr. 21, 2016

(54) SEAT ASSEMBLY AND METHOD OF MAKING AND USING THE SAME

(71) Applicant: GM Global Technology Operations LLC, Detroit, MI (US)

(72) Inventor: Varun Suresh Rao, Bangalore (IN)

(21) Appl. No.: 14/518,015

(22) Filed: Oct. 20, 2014

(51) Int. Cl. B60N 2/70; H01F 1/42; B60N 2/42

(52) U.S. Cl. CPC B60N 2/70; B60N 2/42; H01F 1/42

(57) ABSTRACT

A number of variations may include a product comprising: a seat assembly having a material constructed and arranged to exhibit dry adhesion to grip a contact surface in a first direction and release the contact surface in a second direction.

### TECHNICAL FIELD

The field to which the disclosure generally relates to includes components including, but not limited to, seat assemblies for vehicles.

### BACKGROUND

Currently, some vehicle components, including seat assemblies, allow undesired passenger movement in certain crash events.

### SUMMARY OF ILLUSTRATIVE VARIATIONS OF THE INVENTION

A number of variations may include a product having a seat assembly comprising a material constructed and arranged to exhibit dry adhesion to grip a contact surface in a first direction and release the contact surface in a second direction.

A number of variations may include a method including providing an seat assembly comprising a material constructed and arranged to exhibit dry adhesion to grip a contact surface in a first direction and release the contact surface in a second direction; initiating a deployment of the seat assembly; initiating contact between the contact surface and the seat assembly; and adhering the seat assembly to grip the contact surface in a first direction.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 illustrates a seat assembly according to a number of variations.

FIG. 2 illustrates a seat assembly according to a number of variations.

FIG. 3 illustrates a seat assembly according to a number of variations.

FIG. 4 illustrates a method of using a seat assembly according to a number of variations.

### DETAILED DESCRIPTION OF ILLUSTRATIVE VARIATIONS OF THE INVENTION

The following description of the variations is merely illustrative in nature and is in no way intended to limit the invention, its application, or uses.

The following description of the variations is merely illustrative in nature and is in no way intended to limit the invention, its application, or uses.

As used throughout the specification, the phrases “about” and “at or about” are intended to mean that the amount or value in question may be the value designated or some other value about the same. The phrase is intended to convey that similar values promote equivalent results or effects according to the invention.

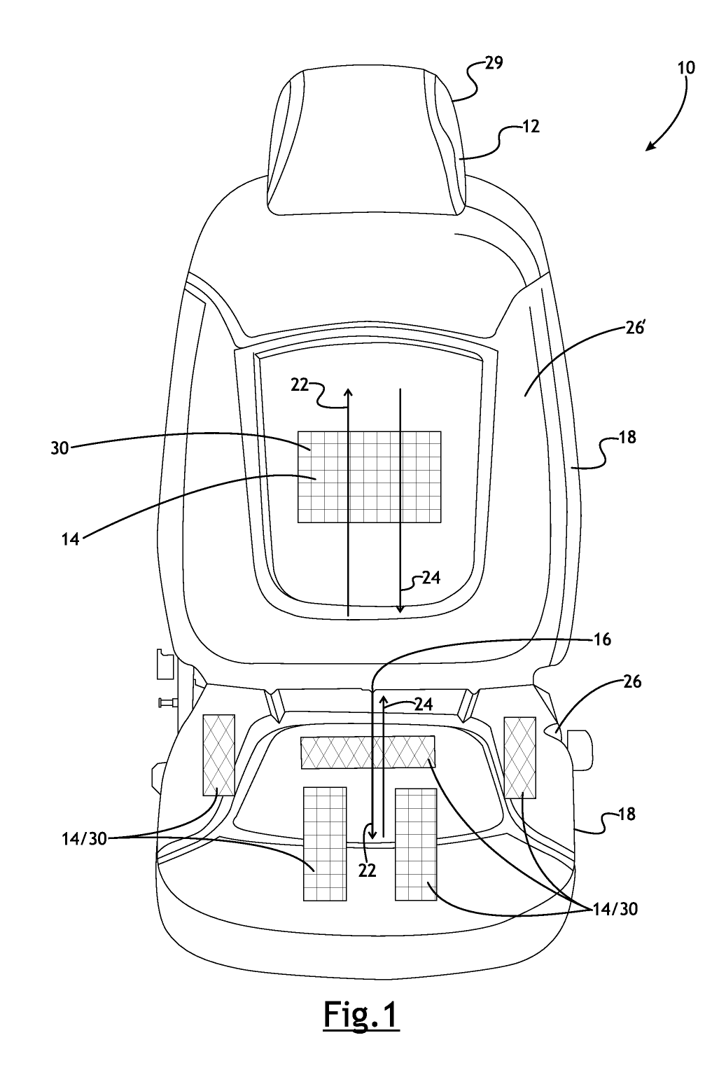

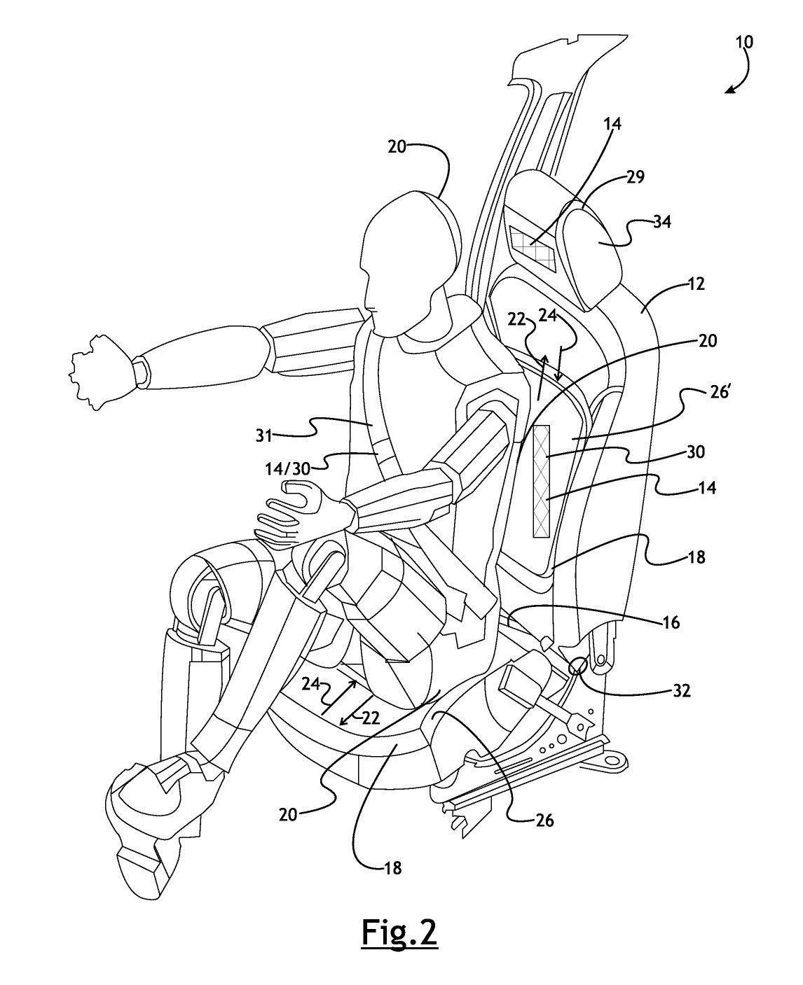

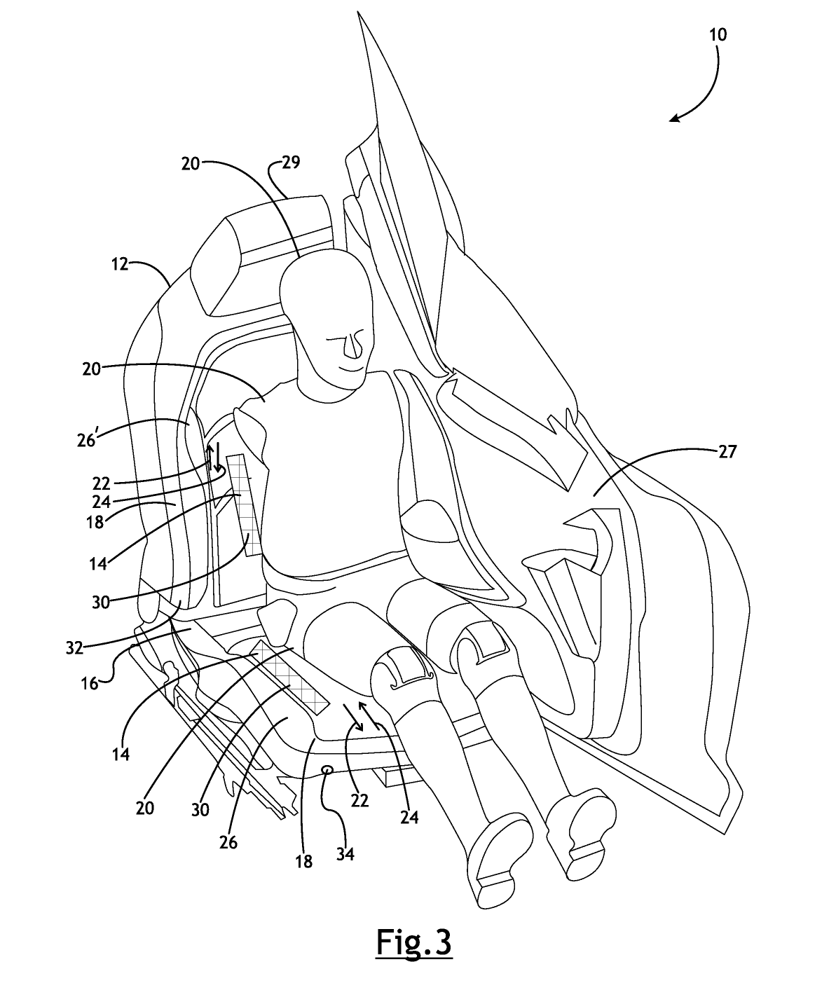

FIGS. 1-3 illustrate a number of variations. In a number of variations, a product 10 is shown. In a number of variations, the product 10 may include a vehicle. In a number of variations, the vehicle 10 may be a watercraft, train, aircraft, automobile, motorcycle, spacecraft, or may be another type. In a number of variations, the product 10 may include a seat assembly 12. In a number of variations, the seat assembly 12 may include a material 14. In a number of variations, the seat assembly 12 may have at least one surface 18 and/or at least one face 26. In a number of variations, the seat assembly 12 may have a plurality of surfaces 18 and/or a plurality of faces 26. In a number of variations, the seat assembly 12 may have a first face 26 and a second face 26′ which may be rotatable in relation to each other in at least one direction. In a number of variations, the seat assembly 12 may include armrests 27. In a number of variations, the armrests 27 may include seat integrated armrests. In a number of variations, the seat assembly 12 may include a headrest 29. In a number of variations, the seat assembly 12 may include a seat belt 31. In a number of variations, the seat assembly 12 may have a center point 16 at the center of a first face 26 and/or on at least one of its surfaces 18. In a number of variations, the seat assembly 12 may have a center point 16 at the intersection between a horizontal first face 26 and a vertical second face 26′. In a number of variations, the material 14 may be constructed and arranged to exhibit dry adhesion to grip a contact surface 20 in a first direction 22 and release the contact surface 20 in a second direction 24. In a number of variations, the first direction 22 may be in the outward radial direction from the center point 16 along a first face 26 and/or second face 26′ on at least one surface 18 of the seat assembly 12. In a number of variations, the first direction 22 may in an outward radial direction from a center point 16 located at the intersection between a horizontal first face or seat 26 and a vertical second face or back 26′. In a number of variations, the second direction 24 may be in the inward radial direction from the center point 16 along a first face 26 and/or second face 26′ on at least one surface 18 of the seat assembly 12. In a number of variations, the second direction 24 may in an inward radial direction from a center point 16 located at the intersection between a horizontal first face 26 and a vertical second face 26′. In a number of variations, the material 14 may be located as at least one patch 30. In a number of variations, the seat assembly 12 may include at least one patch 30 that prevents movement in the axial direction away from the seat assembly 12. In a number of variations, the seat assembly 12 may be a vehicle component. In a number of variations, the contact surface 20 may be at least a part of, attached to, or a surface on a passenger of a vehicle. In a number of variations, the contact surface 20 may be a face, torso, arm, leg, or other appendage of a passenger of a vehicle. In a number of variations, the contact surface 20 may be a piece of clothing attached to or otherwise in contact with a passenger of a vehicle. In a number of variations, the seat assembly 12 may deploy in a vehicle at the onset of a crash condition. In a number of variations, the crash condition may be a side, front, or rear impact into or onto the vehicle 10. In a number of variations, the seat assembly 12 may interact with the contact surface 20 on the onset of a crash condition that causes the seat assembly 12 to deploy. In a number of variations, the material 14 of the seat assembly 12 may grip the contact surface 20 of a passenger and hold the contact surface 20 so that the contact surface will not interact with at least one surrounding hard contact point in a body of the vehicle 10. In a number of variations, this may decrease needed passenger restraint size, decrease seat assembly size, decrease vehicle size, increase vehicle cabin space, allow for additional optimization of passenger restraints, and decrease cost of safety of the vehicle. In a number of variations, the material 14 in the seat assembly may help meet occupational injury requirements in vehicles, may help meet unbelted load case injury requirements, may assist in minimizing/eliminating occupant submarining effect, may assist in minimizing forward excursion in front impact crash scenarios, may reduce knee bolster development costs, may reduce airbag optimization costs, may act as an active restraint to side impact crash scenarios, and may complement existing safety systems to reduce chest loads in front impact crash scenarios. In a number of variations, the material 14 may exhibit dry adhesion to grip the contact surface 20 in a first direction 22 and release the contact surface 20 in a second direction 24. In a number of variations, the material 14 may be in the form of at least one patch 30 on a surface 18 and/or face 26 of the seat assembly 12. In a number of variations, the material 14 may be a nano-fabric material. In a number of variations, the material 14 may be constructed and arranged to grip the contact surface 20 at the onset of a magnetically or electrically actuated signal and release the contact surface 20 at the absence of the magnetically or electrically actuated signal. In a number of variations, the patch 30 may be a plurality of patches 30 that may be in the form of arcing or square bands and may be arranged at different positions radially away from a center point 16 of the seat assembly 12. In a number of variations, the at least one patch comprises a patch that does not allow axial movement away from the seat assembly.

In a number of variations, the seat assembly 12 may be a front seat, back seat, captain's chair, airplane seat, recliner, bench, bar stool, bicycle, car seat, chair, couch, country seat, ejection seat, folding seat, hard seat, infant car seat, jump seat, left seat, right seat, pew, saddle, sliding seat, sofa, stool, throne, or may be another type. In a number of variations, the seat assembly 12 may include a seat belt or other passenger restraint. In a number of variations, the seat assembly 12 may be made of a fabric material. In a number of variations, the seat assembly 12 may be a fibrous material comprising at least one fiber or a plurality of fibers. In a number of variations, the fibers may be textile, natural or synthetic or may be another type. In a number of variations, the seat assembly 12 may include at least one of, plastic steel, stainless steel, copper, nickel, tin, noble metals, zinc, iron, bronze, aluminum, titanium, platinum, shellac, amber, aramid (including Twaron, Kevlar, Technora, Nomax), silk, rubber, synthetic rubber, phenol formaldehyde, neoprene, nylon, polyvinyl chloride, polystyrene, polyethylene, polypropylene, polybenzimidazoles, polyacrylonitrile, PVB, silicone, bioplastic, Teflon, PET, PP, PVDC, PA PTFE, PEO, PPY, PANT, PT, PPS, PPV, PAC, PU, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, alpaca, angora, byssus, camel hair, cashmere, catgut, chiengora, guanaco, llama, leather, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), metallic alloys, combinations thereof, or may be another type. In a number of variations, the seat assembly 12 may contain combinations of the above in varying concentrations and the components may be intermixed. In a number of variations, the seat assembly 12 may be manufactured or woven through weaving, sewing, knitting, braiding, stitching, border stitching, plain weaving, satin weaving, or may be manufactured in another way. In a number of variations, the seat assembly 12 may be a single directional or multi directional weave of fabric. In a number of variations, the seat assembly 12 may have various widths, lengths and/or diameters of fibers as well as in its overall dimensions. A person skilled in the art would understand the process of creating the various seating assemblies 12.

In a number of variations, the material 14 may be sewn or stitched as a patch 30 into the seat assembly 12. In a number of variations, the material 14 may be a micro or nano fabric material. In a number of variations, the material 14 may include at least one fiber and/or may include a plurality of fibers. In a number of variations, the material 14 may be a gecko dry adhesion material. In a number of variations, the material 14 may be a single layer of fiber. In a number of variations, the material 14 may be multilayered. In a number of variations, the material 14 may be manufactured or woven through weaving, knitting, braiding, stitching, boarder stitching, sewing, plain weaving, satin weaving, or may be manufactured in another way. In a number of variations, the material 14 may be single directional or multi directional. In a number of variations, the material 14 may have various widths, lengths and/or diameters of fibers as well as in its overall dimensions. In a number of variations, the material 14 may include a series of curved columnar structures (setae) each bearing trapezoidal-shaped terminal pads (spatulae) that allow for dry adhesion. In a number of variations, the material 14 will adhere in a first direction and release in a second direction. In a number of variations, the material 14 may include a pressure-sensitive adhesive (PSA). In a number of variations, the material may include a permanent and/or removable PSA. In a number of variations, the material 14 may include at least one of, carbon nanotubes, silicon rubber, plastic steel, stainless steel, copper, nickel, tin, noble metals, zinc, iron, bronze, aluminum, titanium, platinum, shellac, amber, aramid (including Twaron, Kevlar, Technora, Nomax), silk, rubber, synthetic rubber, phenol formaldehyde, neoprene, nylon, polyvinyl chloride, polystyrene, polyethylene, polypropylene, polybenzimidazoles, polyacrylonitrile, PVB, silicone, bioplastic, Teflon, PCL PVA, PVDF, FBI, PC, PAN, PLA, PEO, PVP, PS, PVC, PVP, CA, PEI, PEG, PFDMS, PET, PP, PVDC, PA, PE, PTFE, PU PEO, PPY, PANT, PT, PPS, PPV, PAC, EVA, PVAC, SBR, PUR, MMA, epoxies, silicones, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, alpaca, angora, byssus, camel hair, cashmere, catgut, chiengora, guanaco, llama, leather, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), metallic alloys, combinations thereof, or may be another type. In a number of variations, the material 14 may include mixing of Bisphenol A/Epichlorohydrin epoxy resin under the trademark EPON 826 with Polyoxypropylenediamine under the trademark Jeffamine D-230 and decylamine at a mole ratio of 20:0.5:19. In a number of variations, the material 14 may be multilevel hierarchical structures to mimic the setae and spatula of a gecko pad. In a number of variations, the mixture of material 14 may be optimized for desired contact surface 20 adhesion strength.

In a number of variations, the components of a material 14 may include a rigid epoxy and a flexible epoxy. The range of possible crosslinking chemistries which may be used to achieve the material 14 may include alpha, omega-diaminoalkanes, anhydride, or catalytic (as in imidazole type) crosslinking reactions. There are many different ways to achieve the appropriate relationships between the molecular properties. For example, the material 14 may include a rigid epoxy, an epoxy extender, and a crosslinking agent; or a rigid epoxy, a flexible crosslinking agent, and a flexible epoxy; or a rigid epoxy, a rigid crosslinking agent, and a flexible epoxy; or a rigid epoxy, a flexible epoxy, and a catalytic curing agent; or a rigid epoxy, a crosslinking agent, and a diluent; or a flexible epoxy, a crosslinking agent, and a diluent; or a rigid epoxy and a flexible crosslinking agent; or a flexible epoxy and a catalytic curing agent; or a flexible epoxy and a crosslinking agent; and wherein the rigid epoxy may be an aromatic epoxy having at least two epoxide groups, the flexible epoxy may be an aliphatic epoxy having at least two epoxide groups, the epoxy extender may have one epoxide group, and the crosslinking agent may be one of a multi-amine, an organic multi-carboxylic acid, or an anhydride, and the diluent may be a monoamine or a mono-carboxylic acid. In various embodiments, the catalytic curing agent (or catalytic cure) may promote epoxy-to-epoxy or epoxy-to-hydroxyl reactions. The catalytic curing agent may include, but is not limited to, tertiary amines, amine salts, boron trifluoride complexes, or amine borates. The components of the material 14 may be present in an amount sufficient to provide, upon curing of the composition, a material 14 having a glass transition temperature of −90° C. to 200° C. and having a pull-off strength of up to 2000 N/cm² from a substrate or seat assembly 12. In one embodiment, the components of the material 14 composition may be present in an amount sufficient to provide, upon curing of the composition, a material 14 having a change in storage modulus of 2 to 3 orders of magnitude before and after its glass transition temperature. In one embodiment, the components of the material 14 composition may be present in an amount sufficient to provide a material 14 with adhesive material properties when heated above its glass transition temperature.

In a number of variations, the material 14 may be formed by mixing the components of the material and pouring into a mold and curing. In a number of variations, the curing may be done at between 130-300° C. In a number of variations, the material 14 patches 30 may be fabricated using microfabrication techniques on wafers. In a number of variations, the wafers may be cleaned with oxygen plasma and may have the material introduced on the wafer using standard nano or micro fabrication techniques. In a number of variations, the material 14 may be applied as layers mimicking the spatula and setae of the gecko. In a number of variations, positive photoresist may be spun onto the wafer mimicking the spatulae or setae and developed and then etched with material 14 mixture. After the layer may be patterned with material 14 the photoresist layer may be stripped from the wafer. In a number of variations, the wafer may be used as a mold for the patch to create an inverse PDMS replica by mixing pre-polymer and crosslinker at 10:1.

In a number of variations, the material 14 may be made through use of flexible, fibrillar, and adhesive microprotrusion and/or adhesive laid-flat membranes by scalable nozzle-free electrospinning. In a number of variations, the method of forming a material 14 may be by engineering an electrospun non-woven of a highly spinnable polymer, wherein the polymer fiber forming the non-woven may be aligned. In a number of variations the material 14 may be aligned polymeric nanofibers electrospun from a polymer solution. In a number of variations, the material 14 and/or patch 30 may be micropultruded by electrospinning polymeric nanofiber structures and thereafter subjecting the structures to conforming to surface asperities. In a number of variations, an electrospinning apparatus may be used to encourage formation of fabrics in the material 14. In a number of variations, the apparatus may include a spinneret for holding the material 14 mixture for electrospinning from a drum providing a peripheral collecting surface or wafer. In a number of variations, the drum rotates as a jet may be charged, and mixture of material 14 may be drawn toward a collecting surface. In a number of variations, the spinneret moves across the collecting surface to achieve winding/weaving of nanofibers. In a number of variations, the collecting surface rotates and the nanofibers may be formed to form a patch 30. In a number of variations, the diameter, and dimensions of the fibers of the nano or microfiber of the material 14 may be controlled. In a number of variations, the diameter, and dimensions of the patch 30 of the material 14 may be controlled. In a number of variations, in a number of variations the alignment of nano or micro fibers of material 14 can be controlled by the take-up velocity of the drum. The electrospinning apparatus may include a roller electrode to serve a similar function as a spinneret. In a number of variations, the roller electrode rotates partially submerged in the mixture of material 14 and may include multiple protrusions that become coated with mixture of material 14 solution where the fiber may then be drawn onto the collecting surface.

In a number of variations, the material 14 may have controllable adhesion based on a magnetic or electric field. In an number of variations, the material 14 may be constructed and arranged to grip the contact surface 20 at the onset of a magnetically or electrically actuated signal and release the surface at the absence of the magnetically or electrically actuated signal. In a number of variations, a signal may come from a vehicle computer unit CCU 32 based on the onset of a certain condition monitored by sensors 34 in the vehicle 10. In a number of variations, these sensors 34 may include accelerometers, impact sensors, side pressure sensors, wheel speed sensors, gyroscopes, brake pressure sensors, seat occupancy sensors, impact sensors or may be another type. In a number of variations, once the CCU 32 determines a deployment threshold 36 is met for material 14 deployment based on readings from the sensors 34 the CCU 32 will trigger an actuation of the material 14 in the seat assembly 12 to grip the contact surface 20. In a number of variations, the CCU 32 may get signals from the various sensors 34 to determine contact surface 20 angle of impact, severity, force of crash, or may signal a different variable. In a number of variations, the material 14 may be imprinted with electrolytic graining performed on the surface of the patch 30. In a number of variations, by exposing the patch 30 to electrolytic graining (using a conductive metal such as, but not limited to, aluminum) the patch 30 may respond to the magnetic or electrically actuated signal for dry adhesion. In a number of variations, electrolytic anodization may be performed on the surface of the patch 30. In a number of variations, the material 14 may comprises a magnetoactive elastomer (MAE) composite that responds to magnetically actuated signals. In a number of variations, the magnetoactive elastomer may comprise a magnetic gel comprising iron grains.

In a number of variations, the material 14 and/or patch 30 may be in the shape of a rectangular, circular, polygonal, or square pad having a curved structure. In a number of variations the curved structure may be a result of the curing process or the curved structure may also be created by specifically designed molds. In a number of variations, the material 14 and/or patch 30 may be in an arcing band. In a number of variations, the material 14 and/or patch 30 may cover the entire seat assembly 12. In a number of variations, the material 14 and/or patch 30 may be optimized by location for maximum grip effect at the onset of a crash condition. In a number of variations, the material 14 and/or patch 30 may be in the seat belt 31, armrest 27, and/or headrest 29 of the seat assembly 12.

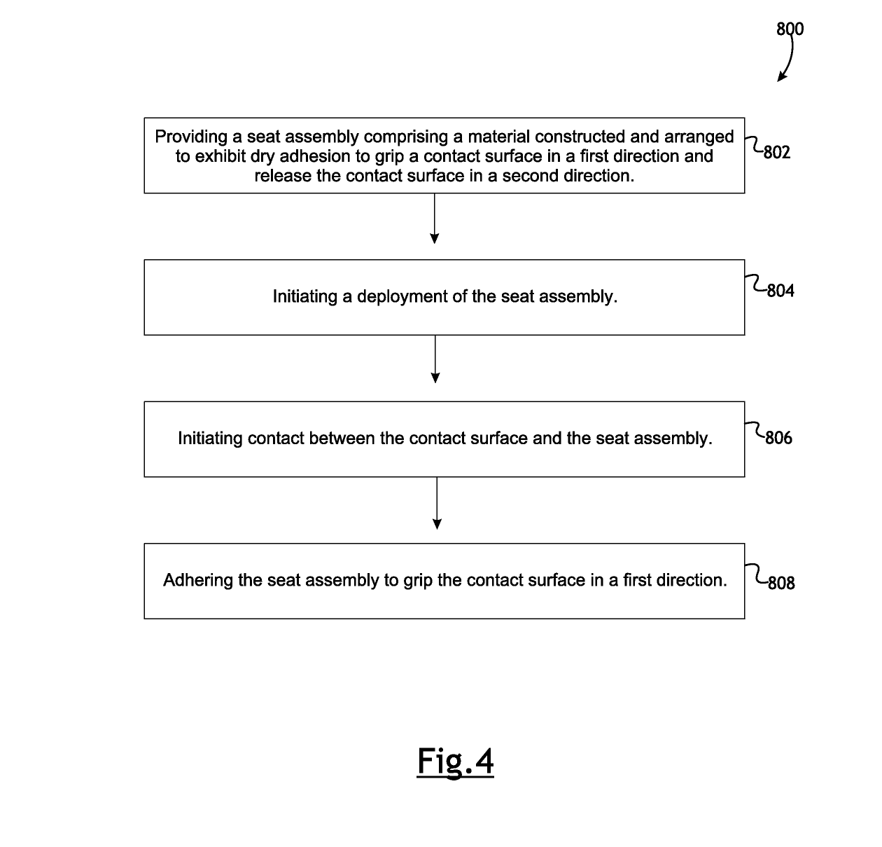

FIG. 4 shows a method 800 according to a number of variations. In a number of variations, the method 800 may include in block 802 providing a seat assembly 12 comprising a material 14 constructed and arranged to exhibit dry adhesion to grip a contact surface 20 in a first direction 22 and release the contact surface 20 in a second direction 24. In a number of variations, the method 800 may further include, in block 804, initiating a deployment of the seat assembly 12. In a number of variations, the method 800 may further include, in block 806, initiating contact between the contact surface 20 and the seat assembly 12. In a number of variations, the method 800 may further include, in block 808, adhering the seat assembly 12 to grip the contact surface 20 in a first direction 22. In a number of variations, the deployment of the material 14 in the seat assembly 12 may be done by the CCU 32. In a number of variations, the deployment of the material 14 in the seat assembly 12 may be based on a threshold 36 as determined by at least one sensor 34. In a number of variations, the deployment of the grip of the material 14 to the contact surface 20 may be electrically or magnetically actuated by a signal from the CCU 32 and/or at least one sensor 34.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include product comprising a seat assembly comprising a material constructed and arranged to exhibit dry adhesion to grip a contact surface in a first direction and release the contact surface in a second direction.

Variation 2 may include a product as set forth in Variation 1 wherein the first direction is an outward radial direction from a center point along a first face of the seat assembly.

Variation 3 may include a product as set forth in any of Variations 1-2 wherein the second direction is an inward radial direction toward a center point along a first face of the seat assembly.

Variation 4 may include a product as set forth in any of Variations 1-3 wherein the material comprises a nano-fabric material.

Variation 5 may include a product as set forth in Variation 4 wherein the material is in the form of at least one patch on the seat assembly.

Variation 6 may include a product as set forth in any of Variations 1-5 wherein the contact surface is attached to a passenger of a vehicle.

Variation 7 may include a product as set forth in any of Variations 1-6 wherein the material is constructed and arranged to grip the contact surface at the onset of a magnetically or electrically actuated signal and release the surface at the absence of the magnetically or electrically actuated signal.

Variation 8 may include a product as set forth in Variations 1-7 wherein the material is a synthetic gecko adhesive made of a magnetoelastomer composite.

Variation 9 may include a product as set forth in any of Variations 1-8 wherein the at least one patch comprises a plurality of patches that are arranged at different positions radially away from a center point of the seat assembly.

Variation 10 may include a product as set forth in any of Variations 1-9 wherein the plurality of patches comprises at least one patch that does not allow axial movement away from the seat assembly.

Variation 11 may include a method including providing an seat assembly comprising a material constructed and arranged to exhibit dry adhesion to grip a contact surface in a first direction and release the contact surface in a second direction; initiating a deployment of the seat assembly; initiating contact between the contact surface and the seat assembly; and adhering the seat assembly to grip the contact surface in a first direction.

Variation 12 may include a method as set forth in Variation 11 wherein the first direction is an outward radial direction from a center point along a first face of the seat assembly.

Variation 13 may include a method as set forth in any of Variations 11-12 wherein the second direction is an inward radial direction toward a center point along a first face of the seat assembly.

Variation 14 may include a method as set forth in any of Variations 11-13 wherein the material comprises a nano fabric material.

Variation 15 may include a method as set forth in any of Variations 11-14 wherein the material is in the form of at least one patch on the seat assembly.

Variation 16 may include a method as set forth in any of Variations 11-15 wherein the contact surface is attached to a passenger of a vehicle.

Variation 17 may include a method as set forth in any of Variations 11-16 wherein the material is constructed and arranged to grip the contact surface at the onset of a magnetically or electrically actuated signal and release the surface at the absence of the magnetically or electrically actuated signal.

Variation 18 may include a method as set forth in any of Variations 11-17 wherein the material is a synthetic gecko adhesive made of a magnetoelastomer composite.

Variation 19 may include a method as set forth in any of Variations 17-18 wherein the at least one patch comprises a plurality of patches that are arranged at different positions radially away from a center point of the seat assembly.

Variation 20 may include a method as set forth in any of Variations 17-19 wherein the plurality of patches comprises at least one patch that does not allow axial movement away from the seat assembly.

Variation 21 may include a method, and/or a product as set forth in any of Variations 1-20 wherein the seat assembly is a front seat, back seat, captain's chair, airplane seat, recliner, bench, bar stool, bicycle, car seat, chair, couch, country seat, ejection seat, folding seat, hard seat, infant car seat, jump seat, left seat, right seat, pew, saddle, sliding seat, sofa, stool, throne, or may be another type.

Variation 22 may include a method, and/or a product as set forth in any of Variations 1-21 wherein the seat assembly includes a computer control unit (CCU) which monitors a number of related sensors within the vehicle.

Variation 23 may include a method, and/or a product as set forth in any of Variations 1-22 wherein once the CCU determines a deployment threshold is met for seat deployment based on readings from the sensors the CCU will initiate a deployment of the seat assembly 12.

Variation 24 may include a method, and/or a product as set forth in any of Variations 1-23 wherein the seat assembly includes at least one of, plastic steel, stainless steel, copper, nickel, tin, noble metals, zinc, iron, bronze, aluminum, titanium, platinum, shellac, amber, aramid (including Twaron, Kevlar, Technora, Nomax), silk, rubber, synthetic rubber, phenol formaldehyde, neoprene, nylon, polyvinyl chloride, polystyrene, polyethylene, polypropylene, polybenzimidazoles, polyacrylonitrile, PVB, silicone, bioplastic, Teflon, PET, PP, PVDC, PA PTFE, PEO, PPY, PANT, PT, PPS, PPV, PAC, PU, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, alpaca, angora, byssus, camel hair, cashmere, catgut, chiengora, guanaco, llama, leather, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), metallic alloys, combinations thereof.

Variation 25 may include a method, and/or a product as set forth in any of Variations 1-24 wherein the material includes at least one of, carbon nanotubes, silicon rubber, plastic steel, stainless steel, copper, nickel, tin, noble metals, zinc, iron, bronze, aluminum, titanium, platinum, shellac, amber, aramid (including Twaron, Kevlar, Technora, Nomax), silk, rubber, synthetic rubber, phenol formaldehyde, neoprene, nylon, polyvinyl chloride, polystyrene, polyethylene, polypropylene, polybenzimidazoles, polyacrylonitrile, PVB, silicone, bioplastic, Teflon, PCL PVA, PVDF, PBI, PC, PAN, PLA, PEO, PVP, PS, PVC, PVP, CA, PEI, PEG, PFDMS, PET, PP, PVDC, PA, PE, PTFE, PU PEO, PPY, PANT, PT, PPS, PPV, PAC, EVA, PVAC, SBR, PUR, MMA, epoxies, silicones, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, alpaca, angora, byssus, camel hair, cashmere, catgut, chiengora, guanaco, llama, leather, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), metallic alloys, combinations thereof.

Variation 26 may include a method, and/or a product as set forth in any of Variations 1-25 wherein the material includes at least one fiber and/or may include a plurality of fibers.

Variation 26 may include a method, and/or a product as set forth in any of Variations 1-25 wherein the material is manufactured or woven through weaving, knitting, braiding, sewing, stitching, plain weaving, satin weaving, or may be manufactured in another way

Variation 27 may include a method, and/or a product as set forth in any of Variations 1-26 wherein the material 14 includes a series of curved columnar structures (setae) each bearing trapezoidal-shaped terminal pads (spatulae) that allow for dry adhesion

Variation 28 may include a method, and/or a product as set forth in any of Variations 1-27 wherein the material includes a pressure-sensitive adhesive (PSA).

Variation 29 may include a method, and/or a product as set forth in any of Variations 1-28 wherein the material includes a rigid epoxy and a flexible epoxy.

Variation 30 may include a method, and/or a product as set forth in any of Variations 1-29 wherein the material patches are fabricated using microfabrication techniques on silicon wafers.

Variation 31 may include a method, and/or a product as set forth in any of Variations 1-30 wherein the material is made through use of flexible, fibrillar, and adhesive microprotrusion and/or adhesive laid-flat membranes by scalable nozzle-free electrospinning.

Variation 32 may include a method, and/or a product as set forth in any of Variations 1-31 wherein the material and/or patch is micropultruded by electrospinning polymeric nanofiber structures and thereafter subjecting the structures to conforming to surface asperities.

Variation 33 may include a method, and/or a product as set forth in any of Variations 1-32 wherein the material 14 is imprinted with electrolytic graining performed on the surface of the patch.

Variation 34 may include a method, and/or a product as set forth in any of Variations 1-33 wherein the material and/or patch is in the shape of a rectangular, circular, polygonal, or square pad having a curved structure.

Variation 35 may include a method, and/or a product as set forth in any of Variations 1-34 wherein the material and/or patch comprises a mixture of Bisphenol A/Epichlorohydrin epoxy resin with Polyoxypropylenediamine and decylamine at a mole ratio of 20:0.5:19.

Variation 36 may include a method, and/or a product as set forth in any of Variations 1-35 wherein the material and/or patch is micropultruded by electrospinning polymeric nanofiber structures and thereafter subjecting the structures to conforming to surface asperities.

Variation 37 may include a method, and/or a product as set forth in any of Variations 1-36 wherein the material and/or patch comprises a magnetoactive elastomer comprising iron grains.

Variation 38 may include a method, and/or a product as set forth in any of Variations 1-37 wherein the material and/or patch undergoes electrolytic anodization.

Variation 38 may include a method, and/or a product as set forth in any of Variations 1-37 wherein the material and/or patch is located in the armrest, headrest, and/or seat belt of the seat assembly.

The above description of select examples of the invention is merely exemplary in nature and, thus, variations or variants thereof are not to be regarded as a departure from the spirit and scope of the invention.

What is claimed is:

1. A product comprising: a seat assembly comprising a material constructed and arranged to exhibit dry adhesion to grip a contact surface in a first direction and release the contact surface in a second direction.

2. A product as set forth in claim 1 wherein the first direction is an outward radial direction from a center point along a first face of the seat assembly.

3. A product as set forth in claim 1 wherein the second direction is an inward radial direction toward a center point along a first face of the seat assembly.

4. A product as set forth in claim 1 wherein the material comprises a nano-fabric material.

5. A product as set forth in claim 1 wherein the material is in the form of at least one patch on the seat assembly.

6. A product as set forth in claim 1 wherein the contact surface is attached to a passenger of a vehicle.

7. A product as set forth in claim 1 wherein the material is constructed and arranged to grip the contact surface at the onset of a magnetically or electrically actuated signal and release the surface at the absence of the magnetically or electrically actuated signal.

8. A product as set forth in claim 1 wherein the material is a synthetic gecko adhesive made of a magnetoelastomer composite.

9. A product as set forth in claim 5 wherein the at least one patch comprises a plurality of patches that are arranged at different positions radially away from a center point of the seat assembly.

10. A product as set forth in claim 9 wherein the plurality of patches comprises at least one patch that does not allow axial movement away from the seat assembly.

11. A method comprising:
providing an seat assembly comprising a material constructed and arranged to exhibit dry adhesion to grip a contact surface in a first direction and release the contact surface in a second direction;
initiating a deployment of the seat assembly;
initiating contact between the contact surface and the seat assembly; and
adhering the seat assembly to grip the contact surface in a first direction.

12. A method as set forth in claim 11 wherein the first direction is an outward radial direction from a center point along a first face of the seat assembly.

13. A method as set forth in claim 11 wherein the second direction is an inward radial direction toward a center point along a first face of the seat assembly.

14. A method as set forth in claim 11 wherein the material comprises a nano fabric material.

15. A method as set forth in claim 11 wherein the material is in the form of at least one patch on the seat assembly.

16. A method as set forth in claim 11 wherein the contact surface is attached to a passenger of a vehicle.

17. A method as set forth in claim 11 wherein the material is constructed and arranged to grip the contact surface at the onset of a magnetically or electrically actuated signal and release the surface at the absence of the magnetically or electrically actuated signal.

18. A method as set forth in claim 11 wherein the material is a synthetic gecko adhesive made of a magnetoelastomer composite.

19. A method as set forth in claim 15 wherein the at least one patch comprises a plurality of patches that are arranged at different positions radially away from a center point of the seat assembly.

20. A method as set forth in claim 19 wherein the plurality of patches comprises at least one patch that does not allow axial movement away from the seat assembly.
